(19) United States
(12) Patent Application Publication
(10) Pub. No.: US 2006/0231595 A1
(43) Pub. Date: Oct. 19, 2006

(54) Method for friction stir welding of dissimilar materials

(76) Inventors: James Florian Quinn, Troy, MI (US); Robert B. Ruokolainen, Livonia, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/105,738

(22) Filed: Apr. 14, 2005

(51) Int. Cl. B23K 20/12

(52) U.S. Cl. 228/112.1

(57) ABSTRACT

A process for adjoining materials by friction stir welding. Two adjacent material segments are heated by localized heating to raise the temperature of each segment along the intersection to a discrete predefined level below the melting point of the particular segment of material being heated. In conjunction with this discrete localized heating, friction stir welding is carried out along the intersection to form the solid state bond.

### TECHNICAL FIELD

This invention relates to friction stir welding of material segments. More specifically, this invention relates to friction stir welding of segments of dissimilar materials using localized selective heating procedures to raise the temperature of the material segments to levels approaching their respective softening points in combination with standard friction stir welding practices so as to permit the joinder of materials having different melting points.

### BACKGROUND OF THE INVENTION

Friction stir welding is a known process in which abutting parts to be joined together are plasticized along their contact surfaces by heat introduced by a rotating friction tool. The friction tool is rotated as it traverses a seam between the work pieces to be joined together. The rotation of the tool produces heat which raises the temperature of the work pieces to their plastic deformation temperature in the immediate vicinity of the interface between the work pieces. As the tool moves along the seam, it mixes the plasticized material from the two work pieces to produce a solid-state bond defining the weld seam. The friction tool commonly is shaped with a large diameter shoulder forming the base of a small diameter probe which is plunged into the joint region while pressure is exerted on the shoulder to maintain a solid contact with the adjacent work pieces.

In the past, the process of friction stir welding has been used successfully in joining pairs of relatively low melting point materials having generally similar melting points. It has also been found that higher melting point materials can be joined together by friction stir welding by preheating the material segments to a common temperature approaching the softening point before application of stir welding. Such preheating may improve processing speed and longevity of the mixing tool thereby facilitating use of stir welding for these materials. However, the melting points of the two materials must be close to one another to avoid undesirable melting of one of the segments.

While friction stir welding has met with success in joining together materials with generally similar plastic temperatures, it has been found problematic to join together materials with substantially different plastic temperatures. This difficulty arises due to the fact that when adequate temperature increases are introduced by friction and/or preheating to raise the higher melting point material to its plastic temperature, the adjacent lower melting point material is concurrently heated beyond its plastic temperature and begins to liquefy. When a work piece material liquefies at the weld interface during the friction stir welding process, a proper seam is not formed.

### SUMMARY OF THE INVENTION

The present invention provides advantages and/or alternatives over the prior art by providing a process whereby materials with dissimilar melting profiles may be adjoined by friction stir welding. The present invention is applicable to adjoining sheets, tube segments, or other geometries as may be desired. The practice of the invention is adaptable to facilitate joinder of materials with grossly different plastic temperatures as well as materials with moderately different and/or similar plastic temperatures.

According to one aspect of the invention, a process is provided wherein two adjacent material segments are heated in the vicinity immediately outboard of their intersection by localized heating practices which raise the temperature of each segment along the intersection to a discrete predefined level corresponding to the plastic temperature of the particular segment material being heated. In conjunction with this discrete localized heating, traditional friction stir welding is carried out along the intersection to form the solid state bond. Thus, the temperature of each segment along the interface is raised to a desired predefined level without undesirable liquefaction of either material.

According to another aspect of the invention, a process is provided for the friction stir welding of materials of grossly different plastic temperature in which localized discrete heating is applied solely to the higher melting point material at a position spaced away from the interface between the segments to be joined so as to raise the temperature of the higher melting point material to the desired plastic level along the interface. The localized heating of the high melting point material on one side of the interface is also used to heat the lower melting point material on the other side of the interface. Due to the naturally occurring temperature gradient across the interface, the lower melting point material is raised to a temperature which is below the temperature of the higher melting point material. Thus, by use of the temperature gradient across the interface, a single heating source can be used to raise the two materials to different temperatures without liquefying either material. Traditional friction stir welding is carried out along the intersection to form the solid state bond.

### BRIEF DESCRIPTION OF THE DRAWINGS

The following drawings which are incorporated in and which constitute a part of this specification illustrate exemplary embodiments and practices in accordance with the present invention and, together with the general description above and the detailed description set forth below, serve to explain the principles of the invention wherein:

FIG. 1 illustrates a friction stir welding technique joining two sheets of material having different melting points;

FIG. 2 illustrates a process for friction stir welding two dissimilar melting point materials in tubular form; and

FIG. 3 illustrates a process for joining together two substantially dissimilar melting point materials by friction stir welding using a single heat source.

While exemplary embodiments and procedures are illustrated herein and will hereinafter be described in detail, it is to be understood and appreciated that in no event is the invention to be limited to such exemplary embodiments and procedures as may be illustrated and described herein. On the contrary, it is intended that the present invention shall extend to all alternatives and modifications as may embrace the broad principles of this invention within the true spirit and scope thereof.

### DESCRIPTION OF THE PREFERRED EMBODIMENT

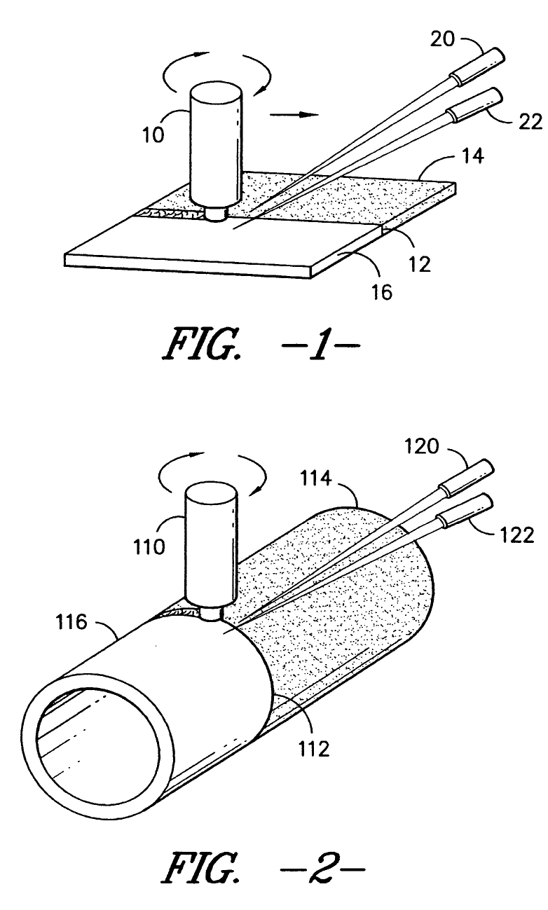

Potentially preferred practices and systems in accordance with the present invention will now be described through reference to the various drawings wherein, to the extent possible, like reference numerals are utilized to designate like elements throughout the various views. Referring now to the figures, in FIG. 1, a system is illustrated for the friction stir welding attachment of two plates of dissimilar melting point. In the illustrated practice, a friction stir welding apparatus 10 such as is available from Esab Welding Equipment AB, of Laxa, Sweden is arranged to traverse an interface line 12 formed by the abutting relation at the edges of a first material plate 14 and a second material plate 16. As will be appreciated, the friction stir welding apparatus preferably utilizes a small diameter mixing probe (not shown) projecting between the plates in a manner as will be well known to those of skill in the art.

The first material plate 14 and the second material plate 16 are illustrated as being formed of different materials that may be characterized by different softening and melting temperatures. However, as will be explained further hereinafter, the illustrated practice is likewise contemplated to be beneficial in joining together plates of similar material.

As illustrated, in the practice of FIG. 1, the first material plate 14 and the second material plate 16 are each subjected to localized discrete heating at a position adjacent to, and outboard of, the interface line 12 such as by use of a pair of lasers 20, 22 or other suitable localized heating practices as may be known to those of skill in the art. In practice, the lasers 20, 22 are preferably independently controlled so as to deliver a predetermined level of heating energy to the individual material plates 14, 16. The level of delivered heating energy is preferably set so as to cause the first material plate 14 and the second material place 16 to be increased in temperature to levels approximating the plastic temperatures for the respective plates.

In the preferred practice, heating is carried out immediately ahead of the friction stir welding apparatus 10 such that upon reaching the heated zones, the apparatus 10 can be used predominantly to mix the plasticized material from the two material plates along the interface line 12 with little if any friction generated heating. Thus, a modified friction stir welding process can be carried out wherein the abutting elements are raised to their individual plasticized temperatures and thereafter mixed by the friction tool rather than being raised to a single homogenous temperature as done in the past. By raising the temperature of each material plate 14, 16, it is possible to join the plates together without the undesirable liquefaction of either abutting surface. Importantly, the practice of the present invention permits a higher melting point material segment on one side of the interface line 12 to be increased to a desired plastic temperature level that may exceed the melting point of a lower melting point material on the other side of the interface line without liquefying the lower melting point material due to the temperature gradient across the interface. Thus, even materials with dramatically different melting points may be joined.

It is to be understood that while the use of lasers 20, 22 may be a convenient and desirable technique for applying heat energy in a closely controlled manner, it is likewise contemplated that other heating mechanisms may also be utilized if desired. For example, it is contemplated that heating elements such as induction coils or the like may be moved ahead of the friction stir welding apparatus 10 as it traverses the interface line 12.

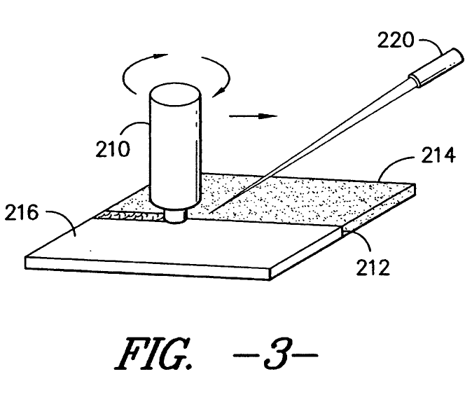

Of course, it is to be understood that the present invention is in no way limited to the joinder of flat plate structures. Rather, it may be used to join segments of virtually any geometry suitable for friction stir welding. By way of example only, and not limitation, a variation of the process described in relation to FIG. 1 is illustrated in FIG. 2 for joinder of two cylindrical or tubular material segments 114, 116. As will be appreciated, this process works in the same manner as in FIG. 1 wherein the friction stir welding apparatus 110 traverses an interface line 112 defined by the abutment between the material segment 114, 116. Lasers 120, 122 or other localized heating elements are used to heat and soften the material segments at positions adjacent to the interface line 112 without surpassing the melting point of either material. The friction stir welding apparatus 110 may thus be used primarily for mixing of the materials having dissimilar plastic temperatures without the occurrence of undesired liquefaction.

As previously indicated, while the systems and procedures illustrated and described in relation to FIGS. 1 and 2 (wherein heating energy is applied directly to both sides of the interface line) may be particularly beneficial in joining together materials of dissimilar melting point, it is also contemplated that such practices may provide benefits even when the materials forming the adjoined segments are the same. In such a situation, the heating energy delivered to both sides of the interface line would be substantially equivalent thereby raising the temperature to the desired level prior to mixing by the friction stir welding apparatus 10.

In the event that the materials to be joined together are of greatly dissimilar melting point, it is contemplated that a single heating element applying heating energy at a position on the higher melting point material adjacent the interface line may be used to effectively raise both segments of material to the desired temperature range to facilitate friction stir welding. A single heating source system is illustrated in FIG. 3, wherein elements corresponding to those previously described are designated by corresponding reference numerals in a 200 series.

In the system illustrated in FIG. 3, the friction stir welding apparatus 210 traverses the interface line 212 between a first material plate 214 of high melting point character and a second material plate 216 of much lower melting point character. By way of example only, and not limitation, it is contemplated that the first material plate 214 may be a steel or high alloy ferrous material while the second material plate, 216 may be a non-ferrous material such as copper, aluminum, magnesium, or the like.

In the illustrated practice, a heating unit such as a laser 220 applies heating energy at a zone ahead of the friction stir welding apparatus 210 slightly outboard of the interface line 212 between the segments of material to be joined. The level of the heating energy applied is sufficient to raise the temperature of the first material plate 214 to its plastic state at the interface 212. The presence of the interface line 212 gives rise to a discontinuity in the conduction of heat away from the zone heated by the laser 220 thus acting in a manner similar to a resister in an electrical circuit. This causes a sharp temperature gradient between the two segments of material. However, due to the high plastic temperature of the first material plate 214, the second material plate 216 is nonetheless still raised to a temperature approaching its softening point thereby facilitating final mixing by the friction stir welding apparatus 210 without friction induced melting. Thus, despite vastly differing melting points, the temperature gradient along the interface line 212 may be utilized to permit efficient friction stir welding.

It is to be understood that while the present invention has been illustrated and described in relation to potentially preferred embodiments, constructions, and procedures, that such embodiments, constructions, and procedures are illustrative only and that the invention is in no event to be limited thereto. Rather, it is contemplated that modifications and variations embodying the principles of the invention will no doubt occur to those of ordinary skill in the art. It is therefore contemplated and intended that the present invention shall extend to all such modifications and variations as may incorporate the broad aspects of the invention within the true spirit and scope thereof.

1. A method of joining a first material to a second material by friction stir welding along an interface, wherein the first material has a higher melting point than the second material, the method comprising the steps of:
applying localized heating from an external heating source to at least the first material at a defined position to form a heated zone along the interface, wherein a portion of the first material within the heated zone is raised to a first temperature and an opposing portion of the second material is raised to a second temperature which is less than the first temperature; and
delivering a rotating friction stir welding apparatus to the heated zone while the heated zone is in an elevated temperature state to blend the first material and the second material along the interface.

2. The method as recited in claim 1, wherein the first material comprises a plate segment and the second material comprises a plate segment.

3. The method as recited in claim 1, wherein the first material comprises a tubular segment and the second material comprises a tubular segment.

4. The method as recited in claim 1, wherein localized heating is carried out by at least one laser.

5. The method as recited in claim 1, wherein localized heating is applied to only the first material.

6. The method as recited in claim 5, wherein the first temperature is in excess of the melting point of the second material.

7. The method as recited in claim 6, wherein the first material is a ferrous metal alloy composition and the second material in a non-ferrous metal alloy composition.

8. The method as recited in claim 1, wherein localized heating is applied to both the first material and to the second material.

9. The method as recited in claim 8, wherein the first temperature is in excess of the melting point of the second material.

10. The method as recited in claim 9, wherein the first material is a ferrous metal alloy composition and the second material in a non-ferrous metal alloy composition.

11. A method of joining a first material to a second material by friction stir welding along an interface, wherein the first material has a higher melting point than the second material, the method comprising the steps of:
applying localized heating from external heating sources to the first material and to the second material at defined positions adjacent the interface to form a heated zone along the interface, wherein a portion of the first material within the heated zone is raised to a first temperature below the melting point of the first material and an opposing portion of the second material is raised to a second temperature, the second temperature being less than the first temperature and further being below the melting point of the second material; and
delivering a rotating friction stir welding apparatus to the heated zone while the heated zone is in an elevated temperature state to blend the first material and the second material along the interface.

12. The method as recited in claim 11, wherein the first material comprises a plate segment and the second material comprises a plate segment.

13. The method as recited in claim 11, wherein the first material comprises a tubular segment and the second material comprises a tubular segment.

14. The method as recited in claim 11, wherein the first temperature is in excess of the melting point of the second material.

15. The method as recited in claim 1, wherein localized heating is carried out by laser heating.

16. A method of joining a first segment of material to a second segment of material by friction stir welding along an interface, the method comprising the steps of:
applying localized heating to the first segment and to the second segment using laser impingement at discrete defined positions on the first segment and the second segment on either side of the interface to form a heated zone along the interface; and
delivering a rotating friction stir welding apparatus to the heated zone while the heated zone is in an elevated temperature state to blend the first material and the second material along the interface.
